(19) United States
(12) Patent Application Publication
(10) Pub. No.: US 2013/0235987 A1
(43) Pub. Date: Sep. 12, 2013

(54) AUTOMATIC MACHINE TO MACHINE DISTRIBUTION OF SUBSCRIBER CONTACT INFORMATION

(71) Applicant: Jose Arroniz-Escobar, Plano, TX (US)

(72) Inventor: Jose Arroniz-Escobar, Plano, TX (US)

(21) Appl. No.: 13/412,900

(22) Filed: Mar. 6, 2012

(51) Int. Cl. H04M 11/00

(52) U.S. Cl. 379/93.17

(57) ABSTRACT

A method and system for replacing contact information without significant human intervention. A subscriber's replacement contact information is automatically sent to specified recipients in a telecommunication system. A program on a subscriber's network appliance upon receipt of a prompt generated by the subscriber to notify contacts of a change or, the program automatically generating instructions when new contact information is installed in a subscriber's network appliance, causes a list of selected recipient addresses to be displayed on the subscriber's appliance display. The subscriber selects the addresses to be notified of the change and the subscriber's network appliance automatically sends the contact information via the telecommunication system's authentication process, to the address selections. Each receiving device has instructions for receiving the replacement contact address information and then replacing the subscriber's current contact address information, that is stored on the device, with the replacement contact address information.

### CROSS-REFERENCE TO RELATED APPLICATIONS

STATEMENT REGARDING FEDERALLY SPONSORED RESEARCH OR DEVELOPMENT: NOT APPLICABLE

REFERENCE TO SEQUENCE LISTING, A TABLE, OR A COMPUTER PROGRAM LISTING COMPACT DISC APPENDIX: NOT APPLICABLE

### BACKGROUND OF THE INVENTION

[Prior art and problems]

The present invention relates to managing a wireless communication device, smart phone (e.g., Apple's iPhone), laptop, netbook or tablet computer, with regard to changing user contact information, such as the device's connection address or substituting a new Directory Number (DN) for a wireless subscriber's smart phone. More particularly, and not by way of limitation, the present invention is directed to a system and method to provide automatic replacement of current subscriber contact information for new subscriber contact information.

A change in user, or subscriber, contact information, such as a new Directory Number (DN) for a smart phone that belongs to a subscriber is always cumbersome if not complicated. The subscriber must make certain that all the entities that use the subscriber's current contact information or address is made aware as soon as possible that the subscriber's contact information should be replaced. When there are many such entities such as family members, banks, schools, doctors, insurance companies employers, etc., the task of making sure all the contacts are notified in a timely manner becomes seriously cumbersome.

There are many problems with current solutions such as: any of the current solutions are clumsy and time consuming; with a manual process the subscriber could forget to notify an important contact; the subscriber may have to be connected or tethered directly to a network, e.g., laptops, desktop computers, etc., in order to make the changes; or a change is sent by the subscriber, but the receiving device doesn't notify the subscriber that the attempt failed.

It would be advantageous to have a system and method for automatically providing address changes to contacts of a subscriber in a fashion that overcomes the above cited disadvantages of the prior art. The present invention provides such a system and method.

### BRIEF SUMMARY OF THE INVENTION

The present invention automates distribution of replacement contact information for a subscriber such as new DN or e-mail address changes being automatically sent to all the subscriber selected contacts (i.e. companies, family members, friends, etc.). This machine to machine interaction is a more accurate and efficient way to provide the new subscriber information to selected contacts currently stored in the subscriber's network device (a smart phone, laptop, netbook, desktop computer, tablet computer). The subscriber's contact information can include email address and “smart phone” directory number.

Thus, in one aspect, the present invention is directed to a method of automatically providing replacement of a subscriber's contact information to specified recipients in a telecommunication system, the subscriber's contact information comprising at least one of a cellphone Directory Number (DN), one or more email addresses and one or more Internet addresses. The method comprises installing an executable program in a non-transitory storage medium.

The program includes instructions used by a microprocessor to, upon receipt of a prompt generated by a subscriber to notify the selected contacts from a list of selectable recipient addresses of a change or automatically generate instructions when new contact information is installed in a subscriber's network device. The recipient addresses stored in the cellphone memory, are displayed on the subscriber's cellphone display. The subscriber selects the addresses to be notified of the change and the subscriber's device automatically sends the replacement contact information to the address selections.

The network device (laptop, desktop, cellphone, tablet, etc.) transmits the one or more selections via the telecommunications system and utilizes telecommunication system authentication procedures for authorizing the transmission, to receiving devices that are associated with the selected addresses. Each receiving device has instructions for receiving the replacement contact address information and then replacing the subscriber's current contact address information, that is stored on the device, with the replacement contact address information.

In another aspect, the present invention is directed to an apparatus that An apparatus, in a telecommunication system, for automatically providing replacement of a subscriber's contact information to specified recipients, the contact information comprising at least one of a cell phone Directory Number (DN) and one or more email addresses

The Apparatus includes a microprocessor associated with a non-transitory storage medium, in which an executable program is stored, and the program includes instructions used by the microprocessor to perform the steps in the executable program. The microprocessor causes a list of selectable recipient addresses, stored in the cellphone memory, to display on the subscriber's cellphone display and the selects one or more contacts from the displayed list of recipient addresses, by the subscriber.

The cellphone transmits the replacement contact information to the one or more selections via the telecommunications system, utilizing telecommunication system authentication procedures for authorizing the transmission, to receiving devices, each receiving device associated with the one or more recipient address selections, each receiving device including instructions for receiving the replacement contact address information and replacing the subscriber's current contact address information, stored on the device, with the replacement contact address information.

### BRIEF DESCRIPTION OF THE SEVERAL VIEWS OF THE DRAWING

In the following section, the invention will be described with reference to exemplary embodiments illustrated in the figures, in which:

FIG. 1 depicts a high-level block diagram of a network in which the present invention can be practiced;

FIG. 2 depicts views of display screens from various devices where the subscriber makes a selection of contacts to notify with the subscriber's replacement contact information in accordance with an embodiment of the present invention;

FIG. 3 is an exemplary flowchart of the present invention according to an embodiment of the present invention; and

FIG. 4 illustrates a high-level block diagram of the flow of the contact information across the Internet for Directory Number and E-mail in accordance with an embodiment of the present invention.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that although the invention is described primarily in the context of a cellular telephone/data network, the invention can be implemented in other forms of wireless networks as well (e.g., a corporate-wide wireless data network, a satellite communication network, etc.).

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form.

It is noted at the outset that the terms “coupled,” “connected”, “connecting,” “electrically connected,” etc., are used interchangeably herein to generally refer to the condition of being electrically connected. Similarly, a first entity is considered to be in “communication” with a second entity (or entities) when the first entity electronically sends and/or receives (whether through wireline or wireless means) information signals (whether containing voice information or non-voice data information) to the second entity regardless of the type (analog or digital) of data signals. It is further noted that various figures (including component diagrams) shown and discussed herein are for illustrative purpose only, and are not drawn to scale.

The following acronyms are used:

DN—Directory number

SMS—Short Message Services

IP—Internet Protocol

E-mail—Electronic Mail

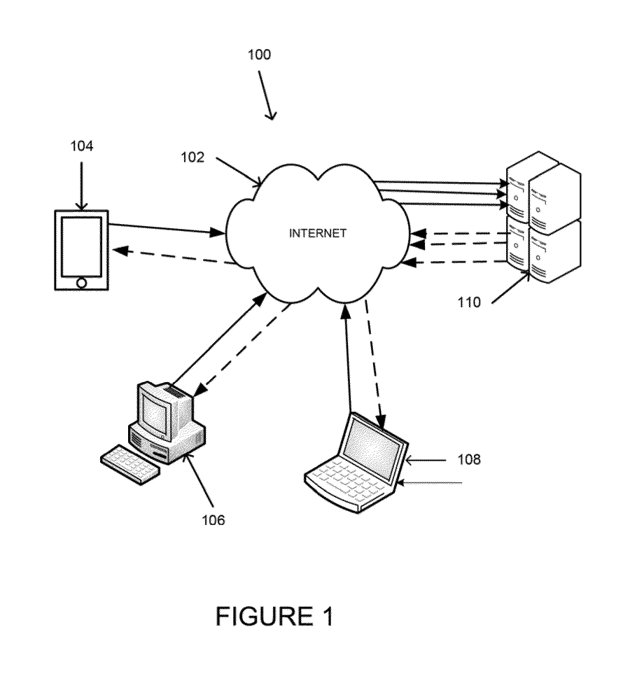

Referring now in detail to the drawings wherein like parts are designated by like reference numerals throughout, there is illustrated in FIG. 1 a high-level block diagram of a network in which the present invention can be practiced. Internet 102 is shown, wherein smartphone 104, desktop computer 106 and laptop 108 are depicted sending a request for a program download from service provider server 110. The requested download, when installed in the requesting device, provides an automatic service for replacing a subscriber's contact information in remote target devices. Server 110 downloads the requested applications to the devices where the subscriber initiates installation of the program.

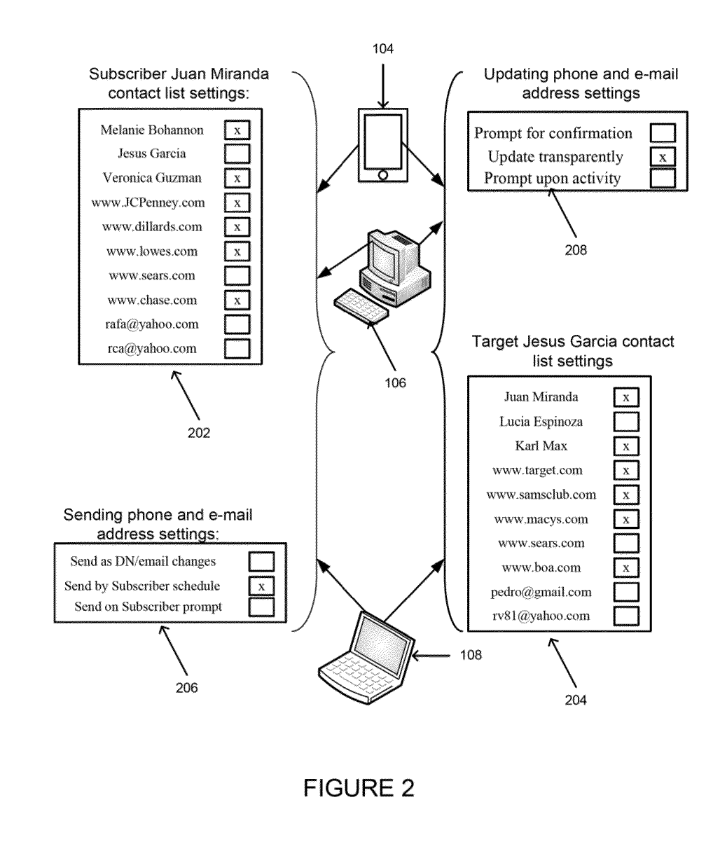

FIG. 2 depicts display screens of contact lists in accordance with an embodiment of the present invention. Depicted is contact list 202 from subscriber Juan Miranda's smart phone 104 and contact list 204 from Jesus Garcia's laptop 108. The replacement information Contact list 202, shows various devices where the subscriber (Juan or Jesus in the case of contact list 204) has made a selection of contacts to notify target contacts with the subscriber's replacement contact information according to an embodiment of the present invention. Jesus and Juan have each other's contact information and both have a send and receive application according to the present invention. Both Juan and Jesus can change contact information with each other as they both have the appropriate application installed.

In Juan's contact list, department stores JC Penney and Dillards are listed as contacts that are to be notified from contact list 202. Included in contact list 204, are Bank of America (boa.com) and SamsClub. The web addresses are entry points for the call (message) from either smartphone 104 or laptop 108 and authentication in order to access the sites takes place as usual. Laptop 108 can target smartphone 104 as well, as Juan Miranda's name appears on the contact list settings so Jesus can mark Juan's contact information.

The contact information that is sent to the target addresses as marked in contact list 202 and contact list 204 already have the required address/directory number in storage. The replacement information is sent as a Directory Number or an email address. As indicated in message sending instructions 206 and 208, the subscriber can schedule the SMS message to be sent at a future time or can send on the subscriber prompt. As illustrated in instructions 208, the subscriber can have the laptop or smartphone either confirm if prompted by the subscriber, carry out all the steps transparently or indicate on the display to the subscriber at the moment of sending a message. Chase bank and some email addresses are not checked to be notified.

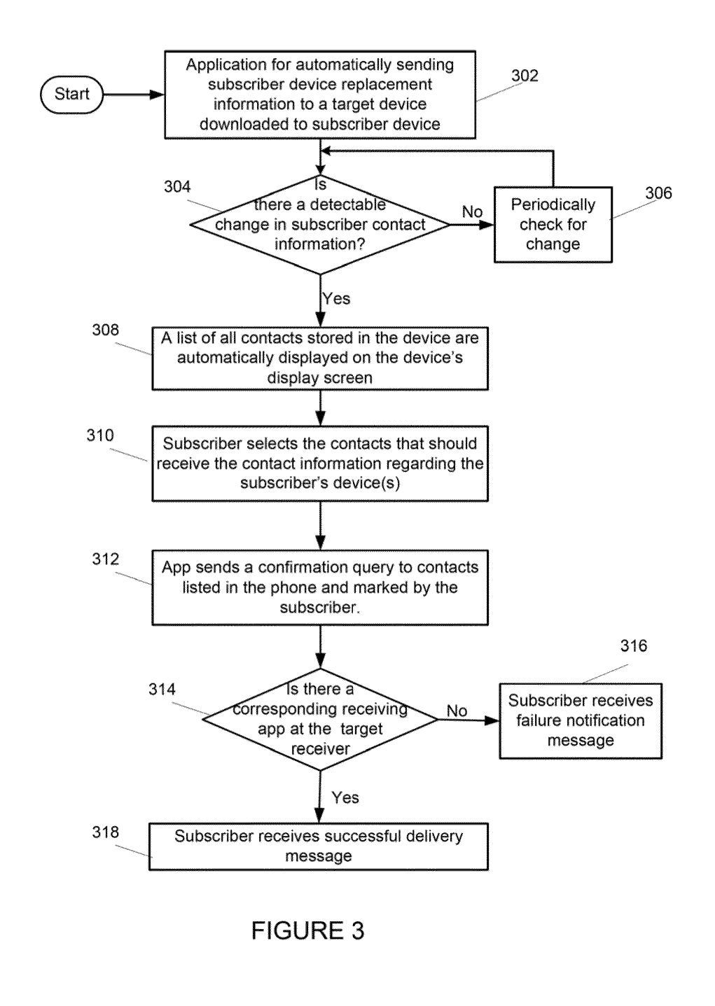

FIG. 3 is an exemplary flowchart illustrating a process according to an embodiment of the present invention. The process begins when a subscriber downloads an application that provides instructions that can be used to automatically send the new or replacement contact information for the device that uses the application. In this example a smartphone is used, but any other device including a laptop or desktop can be substituted. The replacement contact information is directed to a target device, the type of target including individual smartphone devices, individual email addresses, Internet addresses and any other devices that have the subscriber's contact information that needs to be changed and just as importantly have a similar application (step 302). Mostly, the subscriber activates the replacement application but, the application can be set to detect changes in the contact information (step 304) so the application can remind the subscriber to start the process. If there is no detectable change, the process proceeds to step 306, where the subscriber's contact information is checked periodically, to check for a change and notify the subscriber if the subscriber forgets.

If there is a detectable change or the subscriber does not forget and prompts the system, the application displays a list of all the contacts stored in the subscriber's device (step 308). The process then moves to step 310 where the subscriber selects contacts from the displayed list that should receive the contact information.

After the selection is complete, the application sends a confirmation query to the contacts listed in the phone and marked by the subscriber (step 312). If a targeted device does not respond that there is a corresponding receiving application at the target receiver, the subscriber receives a failure notification message (step 316).

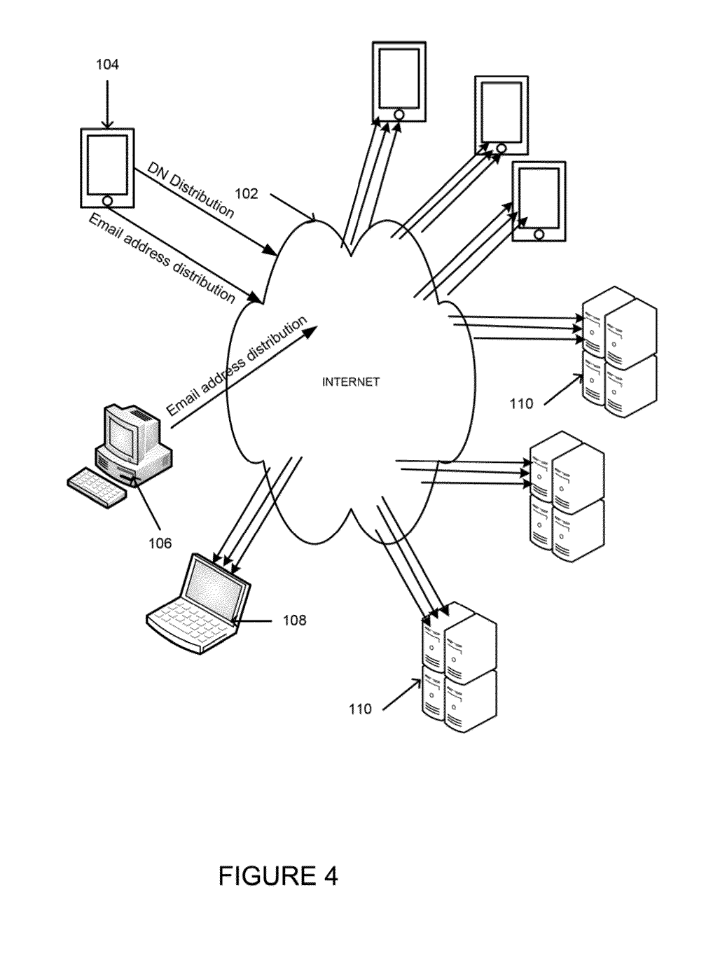

FIG. 4 illustrates a high-level block diagram of the flow of the contact information across the Internet for Directory Number and E-mail in accordance with an embodiment of the present invention. Smartphone 104 and desktop 106 are illustrated sending its Directory Number and email address via the Internet to other smartphones and to email servers and customer servers at business destinations.

Subscribers to Internet connected services such as wireless telecommunications, Internet services, wireline, etc., often are required to change contact information with service providers on the internet. For instance, banking via the Internet typically requires at least one email address for communication between the subscriber and the bank. The bank also requires voice contact information that could include a Directory Number (DN) for the subscriber's cellphone. Information is sent from the bank that is intended only for the subscriber at the subscriber's registered cellphone number or email address. Occasionally, the subscriber (subscriber and user will be used interchangeably throughout the application) has to change the registered email address and the registered DN.

As previously noted the present invention allows for minimal human intervention in the process of changing the contact information for the user and the bank. However, there are times when the subscriber may forget to send required information to a provider on time.

This machine to machine idea will require downloading a service application to all the devices or entities involved in this update individual information task. Once all the applications are in place, every subscriber or entity (sender or receiver) will confirm the distribution list and check to or from whom the new DN or e-mail address will be automatically distributed or accepted. Note that this manual action will be needed to be done as frequent as the subscribers get a new contact, a new credit card (just adding the company to the list, not to enter the credit card data), a new social network account, etc.

Two embodiments:

In a first embodiment a person with a smart phone receives too many wrong number calls so the subscriber requests a new number but retains the same service provider. A new Directory Number is provided to the subscriber and stored in the smart phone which will display the stored contacts of the subscriber. The subscriber selects the specific contacts that will need the new DN and the smart phone then starts automatically sending SMS messages to each of the subscriber selected contacts. Once the SMS message is received by the targeted contacts (e.g., other smart phones, banks, etc.) the new DN will used to replace the old DN. However, the old DN will be kept until this change is acknowledged and approved by the target recipient, which in the case of a smart phone can be accomplished by display of the proposed change and the smart phone user approving by clicking on an approval button. This prompt on screen indication can be displayed at the time the target smart phone is removing the old stored DN of the affected subscriber. On the other hand, the target subscriber could allow this type of change to occur transparently or through a notification for approval (see FIG. 2).

In another embodiment, a subscriber moves internet service to a different service provider. This action can cause the user to change e-mail address. This new e-mail address may be synchronized to this user's social network. Upon synchronizing with the social network the social network can send IP messages to each of the user's selected contacts. Once this message is received by a laptop/desktop computer application, the application will confirm that the target user has selected the social network distributor for replacing the old e-mail address by the new one. However, the old e-mail address will be stored until this change is approved by the target user through a prompt on screen indicator. Again, the target user can select to always allow this type of change transparently or through a notification for approval.

If for some reason the smart phone is dealing with non-smart phones for which only calls and SMS are possible then an automatic voice mail or text message with the proper information will be delivered.

Any receiver can potentially be a sender and vice versa. Security in the execution of the steps of the method of this invention is recognized as necessary but will not be addressed as part of this invention disclosure.

Some of the advantages include: the replacement information is distributed easily and efficiently; with the contact list automatically being displayed, the possibility of forgetting to notify a contact is more remote; the requirement to manually notify all the contacts is reduced; and calling e.g., banks to change a phone number or address is not necessary and listening to long voice recorded menus and waiting for eons just to update contact or personal information is eliminated.

In this detailed description, numerous specific details are set forth in order to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

An embodiment of the invention may include functionality that may be implemented as software executed by a processor, hardware circuits or structures, or a combination of both. The processor may be a general-purpose or dedicated processor, such as a processor from the family of processors made by Intel Corporation, Motorola Incorporated, Sun Microsystems Incorporated and others. The software may comprise programming logic, instructions or data to implement certain functionality for an embodiment of the invention. The software may be stored in a medium accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment of the invention, the media may store programming instructions in a compressed and/or encrypted format, as well as instructions that may have to be compiled or installed by an installer before being executed by the processor. Alternatively, an embodiment of the invention may be implemented as specific hardware components that contain hard-wired logic for performing the recited functionality, or by any combination of programmed general-purpose computer components and custom hardware components. Illustration of the circuitry required for the present invention is well known in the art so the figures are simple block diagrams including computers, servers and cellphones for operating the present invention.

Note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The above described system and method can be implemented by means of hardware comprising several distinct elements and by means of a suitably programmed processing apparatus. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable instructions can be downloaded to a processing apparatus via a network connection.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method in a telecommunication system, of automatically providing replacement of a subscriber's contact information to specified recipients, the contact information comprising at least one of a cellphone Directory Number (DN) and one or more email addresses, the method comprising:
installing in a non-transitory storage medium, an executable program, wherein the program includes instructions used by a microprocessor to perform the following steps:
upon receipt of, a prompt generated by the subscriber to notify contacts of a change or, automatically generated instructions when a replacement is installed, the microprocessor causing a list of selectable recipient addresses, stored in the cellphone memory, to display on the subscriber's cellphone display;
receiving one or more recipient address selections, from the displayed list of recipient addresses, by the subscriber; and
transmitting the subscriber's contact information via the telecommunications system, utilizing telecommunication system authentication procedures for authorizing the transmission, to receiving devices, each receiving device associated with the one or more recipient address selections, the each receiving device including instructions for receiving the replacement contact address information and replacing the subscriber's current contact address information, stored on the each receiving device, with the replacement contact address information.

2. The method of claim 1, further comprising the contact information being sent to each of the list of contacts, which include smartphones, computers and business server website addresses.

3. The method of claim 1, further comprising the target device acknowledging receipt of the replacement information and the installation of the replacement information.

4. The method of claim 1, further comprising in the event that the replacement information is not accepted, sending a message to the subscriber that the information has not been installed.

5. The method of claim 1, wherein the application is supplied by the entity that is responsible for the change of contact information of the subscriber.

6. The method of claim 1, wherein the application is downloaded from a central application server.

7. An apparatus, in a telecommunication system, for automatically providing replacement of a subscriber's contact information to specified recipients, the contact information comprising at least one of a cellphone Directory Number (DN) and one or more email addresses, the apparatus comprising:
a microprocessor associated with a non-transitory storage medium, in which an executable program is stored, wherein the program includes instructions used by the microprocessor to perform the following steps:
upon receipt of, a prompt generated by the subscriber to notify contacts of a change or, automatically generated instructions when a replacement address is installed in a subscriber's cellphone, the microprocessor causing a list of selectable recipient addresses, stored in the cellphone memory, to display on the subscriber's cellphone display;
receiving one or more recipient address selections, from the displayed list of recipient addresses, by the subscriber; and
transmitting subscriber's contact information, via the telecommunications system, utilizing telecommunication system authentication procedures for authorizing the transmission, to receiving devices, each receiving device associated with the one or more recipient address selections, the each receiving device including instructions for receiving the replacement contact address information and replacing the subscriber's current contact address information, stored on the each receiving device, with the replacement contact address information.

8. The apparatus of claim 7, further comprising the microprocessor causing the contact information being sent to each of the list of contacts, which include smartphones, computers and business server website addresses.

9. The apparatus of claim 7, further comprising the microprocessor receiving an acknowledgement from the target device acknowledging receipt of the replacement information and the installation of the replacement information.

10. The apparatus of claim 7, further comprising the microprocessor, receiving a message from the target receiver, in the event that the replacement information is not accepted, that the information has not been installed.

11. The apparatus of claim 7, wherein the application is supplied by the entity that is responsible for the change of contact information of the subscriber.

12. The apparatus of claim 1, wherein the application is downloaded from a central application server.
